(19) United States
(12) Patent Application Publication
(10) Pub. No.: US 2009/0024507 A1
(43) Pub. Date: Jan. 22, 2009

(54) UNIQUE VERSATILE AXPERT EXECUTOR ENGINE WHICH CAN INTERPRET AND EXECUTE TRANSACTION STRUCTURES AND INFORMATION VIEWS TO BUILD INFORMATION SYSTEMS

(75) Inventors: Manavasi Santhanam Sabarish, Bangalore (IN); Tumkur Vajramsetty Jayavanth, Bangalore (IN); Venkatesh Perumal Raghunathan, Bangalore (IN)

Correspondence Address: HAMRE, SCHUMANN, MUELLER & LARSON, P.C., P.O. BOX 2902, MINNEAPOLIS, MN, 55402-0902, US

(73) Assignee: Agile Labs Pvt. Ltd., Bangalore (IN)

(21) Appl. No.: 12/206,075

(22) Filed: Sep. 8, 2008

Related U.S. Application Data
(63) Continuation-in-part of application No. 10/500,919, filed on Jul. 8, 2004.

(30) Foreign Application Priority Data
Jan. 8, 2002 (IN) 0020/MAS/2002

(51) Int. Cl. G06Q 40/00

(52) U.S. Cl. 705/35

(57) ABSTRACT

A technology platform which facilitates the business and domain users to build real time enterprise applications like SCM, CRM, and ERP etc without any knowledge of coding. It saves all business rules, access-control mechanism, business logic, related parts and otherwise middle-tier of any application as metadata within a database. Enterprise applications are built by doing high level definitions and not by writing software programs, the application is defined as process structures that are stored in XML format in the database. It stores the Business logic in the database as “Process Structures” thereby making the application server redundant. The process structures are then read and rendered by the Structure Execution and Management (STEM) which consists of execution services and management services. It can interpret and execute transaction structures and information views. This makes information system building simple and quick. The technology reduces a developer's job to a great extent because it only requires elementary knowledge of SQL.

### CROSS REFERENCE TO RELATED APPLICATION

This application is a Continuation-in-Part of Ser. No. 10/500,919, filed Jul. 8, 2004, which is incorporated by reference in its entirety.

### FIELD OF THE INVENTION

This invention in general relates to the field of building information systems for enterprises. Further, this invention relates to a unique versatile executor engine, which can interpret and execute transaction structures and information views. Hence, the information system thus built can grow along with the needs of the enterprise.

### BACKGROUND OF THE INVENTION

It is to be noted that none of the existing business process solution providers has an executor interpreter that can interpret transaction structures and information views. So, programming skills are essential to maneuver the software. This results in considerable investment of human resources, hardware, and software resources.

It is obvious that the existing business process solution providers target specific business processes limiting their scope of usage and also their flexibility to accommodate changes. Because of this flexibility constraint, such solution providers cannot grow with the needs on time. The architecture is not adaptable to change in business trends and very few options are available to customize and often become redundant. The objects of handling core functionality are huge and hence in a significant measure render them less scalable. The code keeps on changing from customer to customer making them more bug-prone.

The domain expert cannot build solutions without the help of programming team. Huge programming time, less flexibility, considerable maintenance costs (programmers to being involved at each stage of accommodating change), high failure rate, lack of versatility (provide solutions to specific business needs) makes it very difficult to built and maintain information systems.

It is envisaged to invent an “executor engine” which encompasses and caters to each and every requirement of business process. It is versatile, flexible, substantial time and cost-saving, user friendly, easily scalable, no programming skills required and all importantly no failure and never redundant. It will be apparent to those skilled in the art that the objects of this invention have been achieved by providing executor interpreter that can interpret transaction structures and information views which is unique in nature of unlike existing business process solution providers. Various changes may be made in and without departing from the concept of the invention. Further, features of some stages disclosed in this application may be employed with features of other stages.

Profit 5RM technology has been bettered in the past years after the patent application Ser. No. 10/500,919 has been submitted. Profit 5RM including the enhancements has been named as AXPERT. Therefore, the scope of the invention is to be now determined by the terminology of the following claims and the legal equivalents thereof.

### SUMMARY OF THE INVENTION

This invention may be summarized, at least in part, with reference to its objects. The primary object of the invention is to invent an executor engine, which interprets and executes the process structures.

It is another object of the invention to invent a new methodology, which simplifies business software development.

It is another object of the invention that any application can be done nearly 70% faster than doing application using programming languages.

It is another object of the invention is to store the whole business functionality in the database as process structures and when the needs of the enterprise change, the changes can be made to the process structures.

It is another object of the invention to provide a service oriented architecture, as the functionality of the AXPERT STEM can be deployed under a web server.

It is another object of the invention to provide easy maintenance being a very small application it does not require elaborate maintenance activity.

It is another object of the invention to provide a quick technology adoption without overhauling the existing application.

It is another object of the invention to provide a transparent database structure with adequate security.

It is another object of the invention to provide remote login services to connect the database from any remote location.

It is yet another object of the invention to provide central web engine where the process structure can be accessed through browser from anywhere.

Thus, the embodiments described herein provide an improved unique versatile executor engine which can interpret and execute transaction structures and information views to build information systems comprising of software tools Profit 5RM executor engine and Profit 5RM builder. Both of said tools are merged into a single STEM application (structure, execution and management component) where the executor engine is characterized to interpret and execute process structures to build information system, and the said AXPERT (network component) will access the process structures from the remote server and work on the data in the local LAN.

In one embodiment, the said invention comprising of STEM includes structure execution services and structure management services.

In one embodiment, the structure execution services consists of GUI services, Execution services and Transaction management services.

In one embodiment, the structure management services consists of structure definition services and table management services.

In one embodiment, the STEM is interlinked with the desktop user and the database.

In one embodiment, said data base consists of process structure and transaction data.

In one embodiment, said invention is enhanced to work under web server through internet.

In one embodiment said invention is enhanced to work with a central application and local database.

In one embodiment, said AXPERT STEM is connected with the central server where said central server consists of structure management services and process structures.

In one embodiment, the end user and remote user are interlinked with said AXPERT STEM and said central server through internet.

In one embodiment, said AXPERT STEM is interconnected with the customer data server, said structure execution services and said web server through internet.

These and other objects of the present invention will be more readily apparent when considered in reference to the following description, when taken in conjunction with the accompanying drawings.

### BRIEF DESCRIPTION OF THE DRAWINGS

FIG. 1 is a flowchart that illustrates the enhanced architecture diagram for AXPERT technology.

FIG. 2 is a flowchart that illustrates AXPERT technology which is enhanced to work under a web server

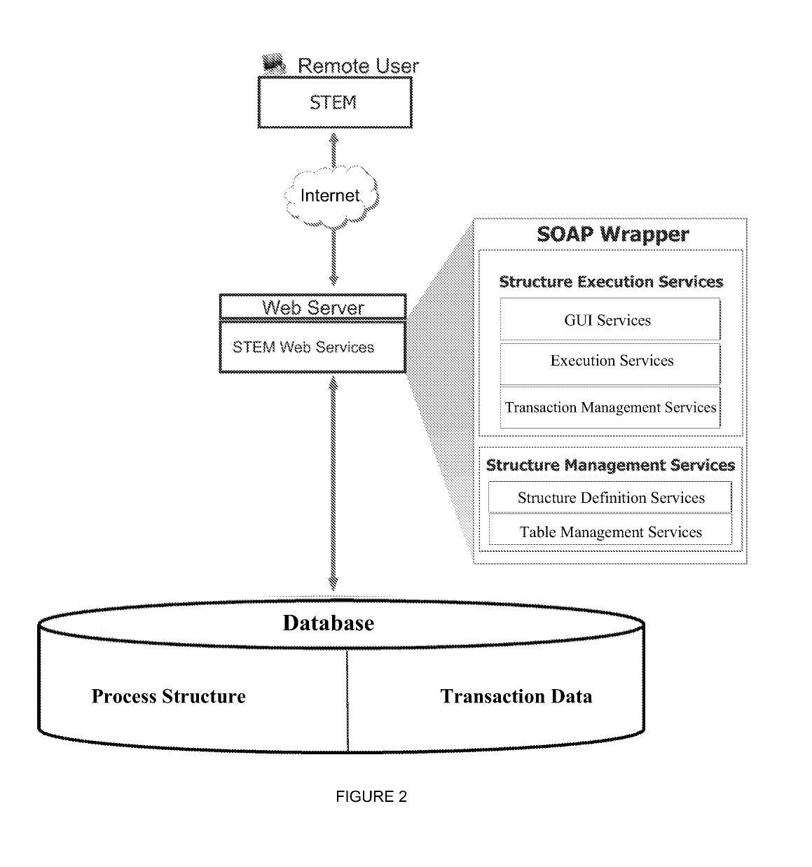

FIG. 3 is a flowchart that illustrates AXPERT technology that has been enhanced to work with a central application and local database architecture framework

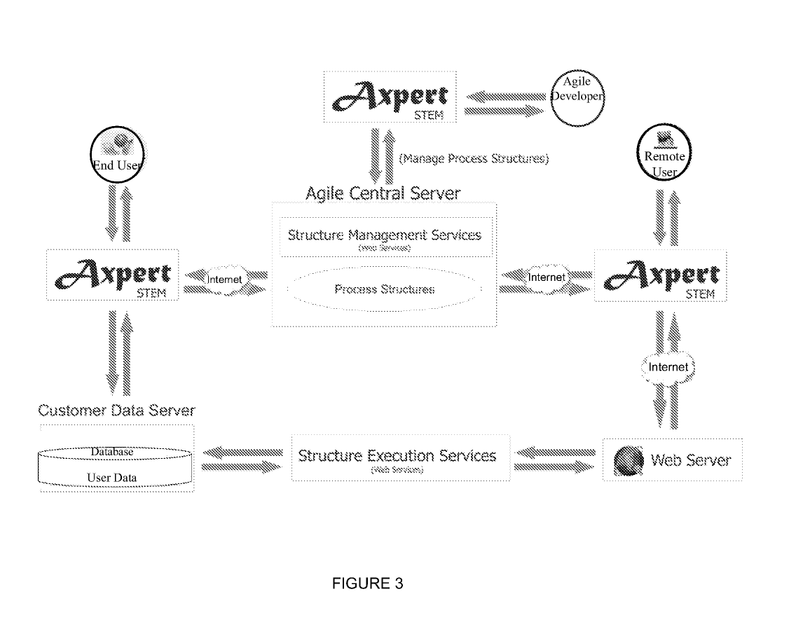

### DETAILED DESCRIPTION OF THE INVENTION

The following description is presented to enable any person skilled in the art to make and use the invention, and is provided in the context of particular applications of the invention and their requirements. The present invention can be configured as follows:

The present invention provides a Profit 5RM Technology, wherein the executor engine interprets and executes the transaction structures and information views. The transaction structures and information views are described in detail in the claims of the original patent. It is described here that the transaction structures and information views are called as Process Structures. The process structures are just a collective name for transaction structures and information views. Hence, the executor engine interprets and executes process structures (instead of transaction structures and information views).

A transaction structure describes a set of related database tables. Each table in a Transaction Structure is defined as a data container. There can be any number of data containers in a transaction structure. Every field in the table is defined as an input field within the data container. The computation & validation rules can be defined for every input field. Further, a sql statement can be associated with an input field. In this case, the value for the input field can be a selected from the given sql result. AXPERT STEM provides services to which data can be submitted to Transaction Structures and not to individual tables. When data is stored into a transaction structure, the data will be automatically stored into different tables in the transaction structure and relationships are automatically built. The computation and validation rules are applied on the submitted data before storing into the database tables.

There are two applications viz Profit 5RM executor Engine and Profit 5RM Builder in the original patent. These two applications are merged into a single application named as the STEM application. STEM stands for Structure Execution and Management.

The executor engine consists of a component named as Process Request Server (PRS) in the original patent. It has to be renamed as Structure Execution services and Structure Management Services.

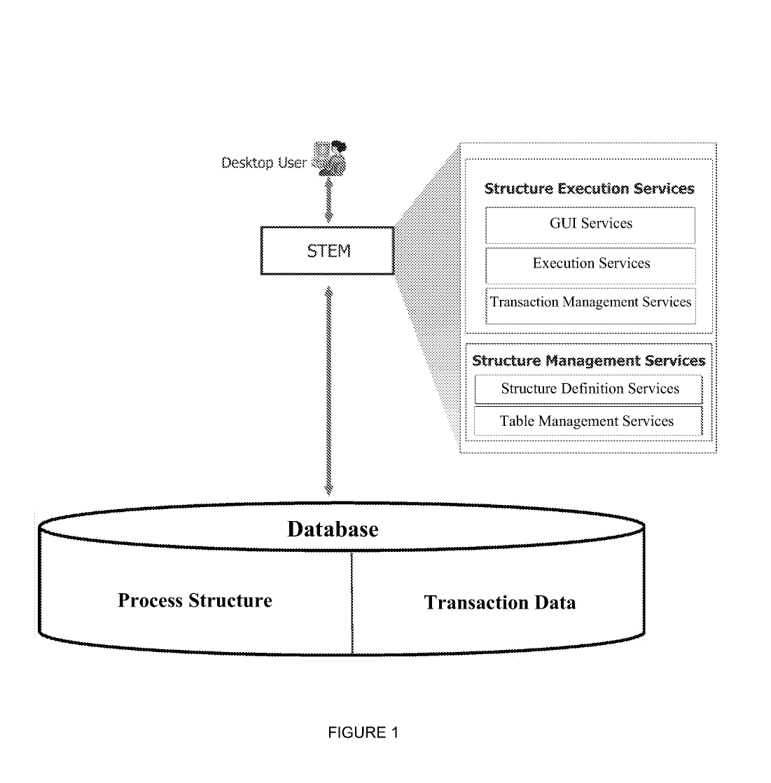

Refer to FIG. 1 for the enhanced architecture of AXPERT. The STEM i.e., structure execution and management interacts between the desktop user and the database, and understands the information system required by the organization. The STEM is comprised of GUI services, Execution services, Transaction Management services, structure definition services and table management services. Similarly the AXPERT technology is enhanced to work under a web server, where the STEM web services are interlinked between the web server, database and the internet. The information system is analyzed and made into simple structures

AXPERT has been enhanced to work with a central application and local database architecture. In this case, the process structures reside in a central remote server. AXPERT will access the process structures from the remote server and work on the data in the local LAN. AXPERT STEMs are connected to the central application server called the central server.

A transaction structure can be mapped to another transaction structure. The map is defined as a Transaction Generator Map (Genmap) in the source transaction structure. In this case, when ever data is submitted to the source transaction structure, the relevant data (as defined in the map) is submitted to the target transaction structure also. The computation & validation rules in the target transaction structure are executed and the data is saved to the target transaction structure also. In case, some of the validation rules defined in the target fail, then the source transaction is also rolled back.

When data is stored into a transaction structure, it can be made to update a record in another table. This is achieved by defining a Master Detail Map (MDMap). This map is also executed as part of a single database transaction.

AXPERT STEM automatically associates an input form to a transaction structure. The AXPERT STEM also provides a form design feature. The form that is generated default by AXPERT can be changed by the developer. This will enable users to build forms with user interface of their choice. Navigation from the form can be defined as hyper links in the structure.

Actions can be defined as part of the transaction structure. AXPERT STEM provides basic tasks to save data, load data, send email, associate a print format, export data, import data, etc. These basic tasks can be combined together into an action. The actions can be associated with buttons that can be dropped on the form or can be submitted to the AXPERT background processor. In this case, the action will be performed at specified time intervals.

An Information View describes a tabular set of information drawn from the database using SQL statements. The result of SQL statement is shown in a tabular/grid format which can be laid out as per need. The layout of the view is made part of the IView structure. Similar to a transaction structure, the actions and hyper links can be described as part of the IView. An IView can be integrated along with transaction structures to provide meaningful navigation in the application. An information view can be used to present reports and queries to users. The process structures can be dropped as components onto pages that are viewed by end user. A page in AXPERT is a collection of containers that can hold one or more related structures along with option text and images.

A domain expert interacts with the end user and understands the information system required by the organization. The Graphical User Interface Layer (GUIL) presents a user interface for the end user based on the Transaction Structure. The GUIL interacts with the end user and submits various requests for transaction processing or information request to the Process Request Server [PRS]. Process Request Server (PRS) which is to be renamed as Structure Execution services and Structure Management Services provides services to process transactions and information requests. The Transaction Structures govern the transaction processing done by the PRS. The Information Views govern the processing of information requests. In this approach, software programs are not written to make an information system. Instead, an information system is made into Transaction Structures and Information View and stored in the database.

All the functionality that is provided in the AXPERT STEM is also available as AXPERT web services (AWS). These web services can be deployed under a web server. This will provide the same functionality under a browser.

Thus, an application is built in AXPERT by defining structures first and then organizing the structures into pages according to the need of the end user. This way of building an application is termed as Structure Driven Method (SDM).

What is claimed is:

1. A tool for interpreting and executing transaction structures and information views to build an information system comprising:
a structure, execution and management component that includes an executor engine that interprets and executes process structures and a builder that builds the information system; and
a network component for accessing the process structure from a remote server and providing data to the structure, execution and management component via a local area network.

2. The tool of claim 1, wherein the structure, execution and management component further comprises structure execution services and structure management services.

3. The tool of claim 2, wherein the structure execution services comprises graphical user interface services, execution services and transaction management services.

4. The tool of claim 2, wherein the structure management services comprises structure definition services and table management services.

5. The tool of claim 2 wherein the structure, execution and management component is interlinked with the desktop user and a database.

6. The tool of claim 5, wherein the database comprises process structure and transaction data.

7. The tool of claim 2, wherein the tool is accessed through a web server via the Internet.

8. The tool of claim 2, wherein the tool works with a central application and a local database.

9. The tool of claim 8, wherein the tool is connected to a central server comprising the structure management services and the process structures.

10. The tool of claim 1, wherein an end user and a remote user are interlinked with said tool and said central server via the Internet.

11. The tool of claim 1, wherein the tool is interconnected with a customer data server, said structure execution services and said web server via the Internet.
